(19) United States
(12) Patent Application Publication
(10) Pub. No.: US 2008/0083338 A1
(43) Pub. Date: Apr. 10, 2008

(54) Installation for Reheating Portioned Chilled or Frozen Snack Food Products

(76) Inventor: Walter Niemetz, Jussy (CH)

Correspondence Address: Ronald R Santucci;Frommer Lawrence & Haug, 745 Fifth Avenue, New York, NY, 10151, US

(21) Appl. No.: 11/794,401

(22) PCT Filed: Dec. 29, 2005
(86) PCT No.: PCT/IB05/03902

§ 371 Date: Jun. 27, 2007

(30) Foreign Application Priority Data
Dec. 30, 2004 (EP) 04031002.1

(51) Int. Cl. H05B 6/80; H05B 6/64

(52) U.S. Cl. 99/326; 219/679

(57) ABSTRACT

The invention relates to an installation for reheating portioned chilled or frozen snack food products packaged in a lower and upper hinged package parts closed by cooperation of snap means. It comprises a compact oven provided with a first cavity section (41a) infrared heating sand a second cavity section heated by microwave means (64). The package with the food to reheat is taken into the cavity (41), automatically opened and the food only is unload on a moving grill/fork device (20). The grill/fork (20) moves sidewards inside the microwave cavity section (41b) for microwave heating. A door (41c) moves with grill/fork (20) to isolate the microwave heated cavity. After the microwave heating the grill/fork moves inside the infrared cavity section (41a). At the end the food is automatically unloaded back to the package.

The present invention relates to an installation for reheating portioned chilled or frozen snack food products packaged in a lower and upper hinged package parts closed by cooperation of snap means, comprising a compact oven provided with microwave and infrared heating section means located inside the oven cavity, means for reading a heating instructions label located on the package of the food product and CPU means for controlling the compact oven.

### BACKGROUND OF THE INVENTION

The consumption of individually packaged cold sandwiches and of other snack products for quick consumption is one of the most well established growth markets in the global food industry. Nevertheless, 90% of all products sold in gasoline stations, kiosks, supermarkets, offices or households, are consumed in a cold state. The traditional products consumed in a warm state, like for instance pizzas, paninis, baguette's, toasts, quiches, strudels etc. are still not offered by the industry as separately packaged snack helpings which can be heated within one minute by the user/consumer himself at the point of sales or at home.

What is needed therefore is a system whereby the food industry can distribute frozen or chilled produced single snack portions, for hot or warm consumption, in a functional portion package, whereby the food products are secured during transportation, and packaged in a special merchandising configuration (snack towers) for easy and attractive placement at the point of sales or stored at home.

What is furthermore needed in combination with the functional packaging is a compact convenient to use automated hybrid re-heating equipment integrated in a compact oven, to heat the food product at the point of sales, or in households, within one minute. Further what is needed at the point of sales is an easy attractive merchandising display of the snack products and handling instructions via a TV Video screen integrated in the oven.

Usually, the packaged or unpackaged food product is introduced by the consumer or the sales personnel into the heating device (oven). After a heating period of time the heated food product is taken manually out of the heating device (oven) and returned to the consumer with the heated package, or if it was heated without the package, it is put manually back to its original package (if solid container is used—with film wrapping it is not possible) or placed into a new package and handed over to the consumer. In all these operations are time, staff and additional extra material cost involved and carry a hygienic risk, as very often the personal preparing the food, cashes in also money, and touches at the same time the food. It is for these reasons, that in the European Union the Food & Drug law forbids that the person who is touching money can prepare food. Further, the heating time is not accurately adapted to the food product, the manipulation of the package or the food product does not allow a correct hygienic handling, the manual operation of the heating device is time consuming and erroneous operation occur. A waste factor of 15% calculated from the net sales price of the food product, is factored into the consumer sales prices as a trade standard, to cover the losses with the handicaps by the existing practice.

### SUMMARY OF THE INVENTION

The installation of the present invention aims to avoid the above drawbacks, saves cost and provides hygienic food safety for the consumer and offers several other improvements in this field as that will be clearly evidenced in the description that follows.

The installation according the present invention is defined in claim 1 and the dependent claims.

The present invention provides an installation that conveniently distributes, stores, and displays the merchandise, un-packages the snack food portions, reheats, and repackages, the snack food product and/or ready made frozen or chilled portion menus in a very short time, at the point of sales or households without manual involvement, or at any other place as for example, supermarket, kiosk, offices, Fast-food restaurants, etc.

The advantages of the preferred embodiment comprising all the claimed features are the following. The installation allows automatic opening and removing of the snack food products from the package container into the re-heater oven, provided with a moving snack grill in combination with a cavity wall which divides one bigger cavity in two heating sections, one for microwave mono mode heating and the other cavity with infrared heating. After the heating process the snack food products are moved by the grill to a schablone/receiver where the heated food snack will be automatically repackaged into the single portion packages, which are then automatically closed and delivered in a tray to through exit clap of the oven for save and convenient take away by the consumer. Inside the oven cavity, means for reading a heating instructions from the label, which is a RFDI chip, melted into the single portion packaging containers of the snack food product and CPU means for control by the oven identifying the type of snack product, the infrared temperature measurer controlling start and ongoing temperature of the food product and the final temperature (not exceeding 55° C.), the needed heating time calculated per heating system (mono mode microwave or infrared), plus the daily sales per unit and per item and technical maintenance data by satellite to the main frame computer. A TV screen means for handling instructions for the consumer at the point of sales and entertainment during the re-heating time, or advertising for synergy sales, like soft drinks with hot snacks.

The installation is a fully automated and save equipment for a variety of hot snack's for self-service but with no staff or additional extra packaging cost involved.

The compact oven is provided with a security clap (door), integrated into the outside design which covers and secures the whole equipment during the operation.

The hybrid heating method, consisting of microwave energy, preferably mono mode energy, in combination with infrared devices, achieve crisp product quality (if it is requested by the characteristics of the food products quality) in an extremely short time, for example from chilled (+5° C.) or frozen product conditions (−18° C.), to +50° Celsius, heating a frozen ¼ pizza or panini portion with a weight of approx. 140 to 200 gr. within 60-80 seconds in the expected crisp quality

Further the energy needed by the compact oven, is not more than 16 Ampere, therefore economically in a “plug and play” method, everywhere to use.

The compact oven operation is instructed the heating instructions by a RFID (Radio Frequency Identification) chip, integrated into the packaging container of the food product, programmed with the heating parameters to select the optimum combination for the identified snack food item of the two heating sources, while a infrared heating sensor device allows to analyse the food products temperature on the start and adjust the heating procedure during the heating process, for the optimum homogenous final food product reheating quality, and controlling that the heat of the final product is save for the user/consumer and not exceeding 55° C.

The compact oven operates with an automated “in and out” method, taking the snack food product out of the single portion package and into the compact oven's cavities, plus returning the snack food product into the package and closing it for convenient and save handling for the consumer, after the heating process is completed. Reheating without the package eliminates the risk of penetration of chemical substances from the plastic folio-binders/print colours etc., into the snack food products during a heating process. Furthermore, the re-packing of the hot food product into the same package as it was used for the frozen or chilled fabrications and distribution until the heating at the point of sales, is saving extra packaging cost and is environment friendly. It is notable, that in order to achieve crispness, which is necessary for 80% of all hot snack food products i.e. (Paninis, Strudels, Pizzas etc.) the heat of 280-320° C., generated with infrared must be able penetrate snack food products surface directly (without the package), in order to dry it out, and by that removing the moist, thereby making it crisp.

Different shaped food products can be reheated allowing maximum versatility with the installation thanks to the shape of the schablone/receiver.

The invention will be described with the help of the attached drawings.

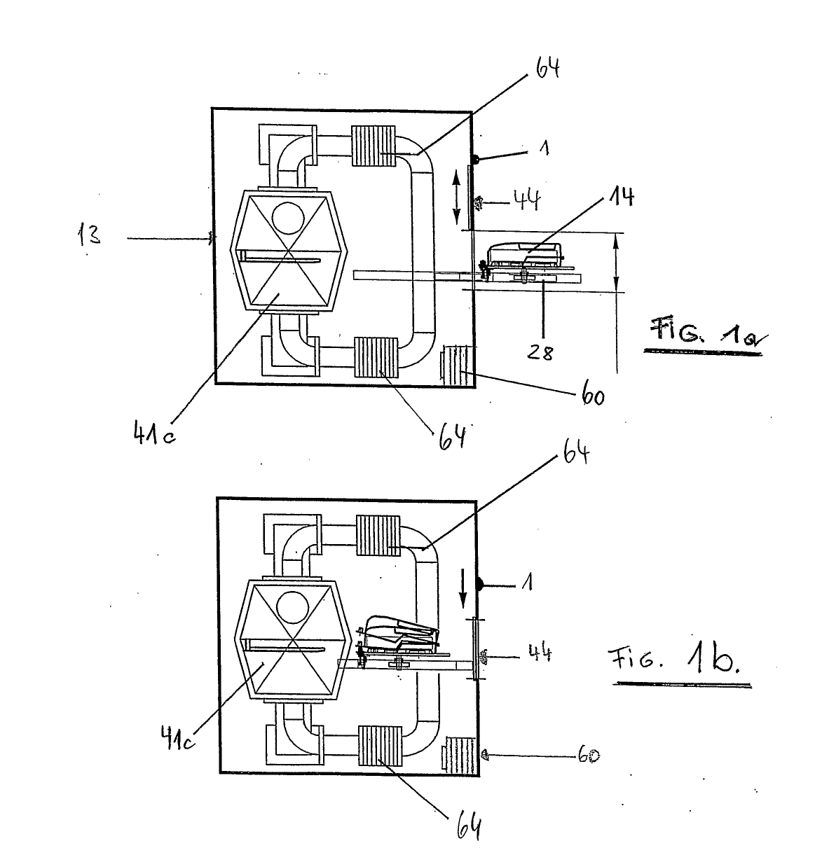

FIG. 1a, and 1b is a side view and cut of the compact oven and the automated in and out system.

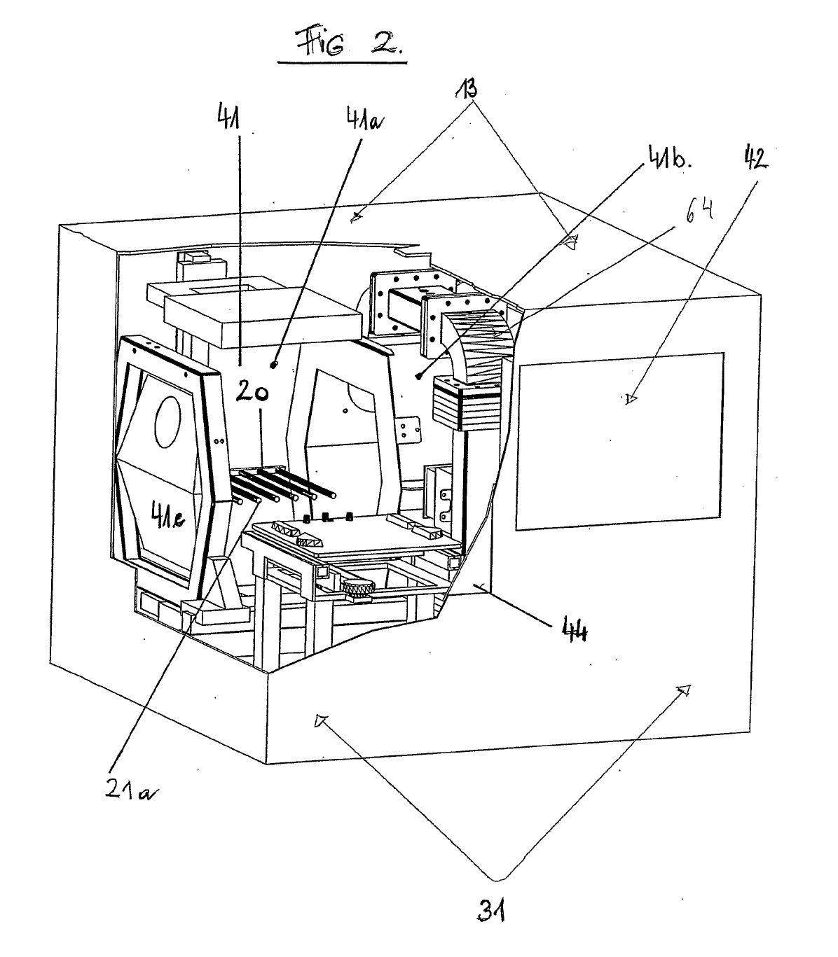

FIG. 2 shows the oven with the clap door and the integrated TV information video screen, the housing box being partially cut.

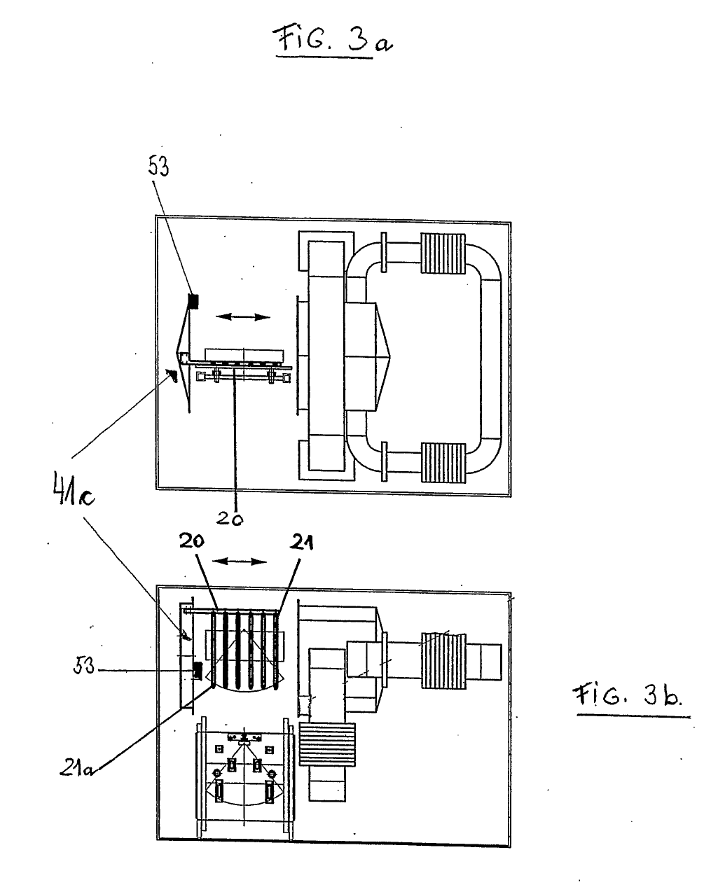

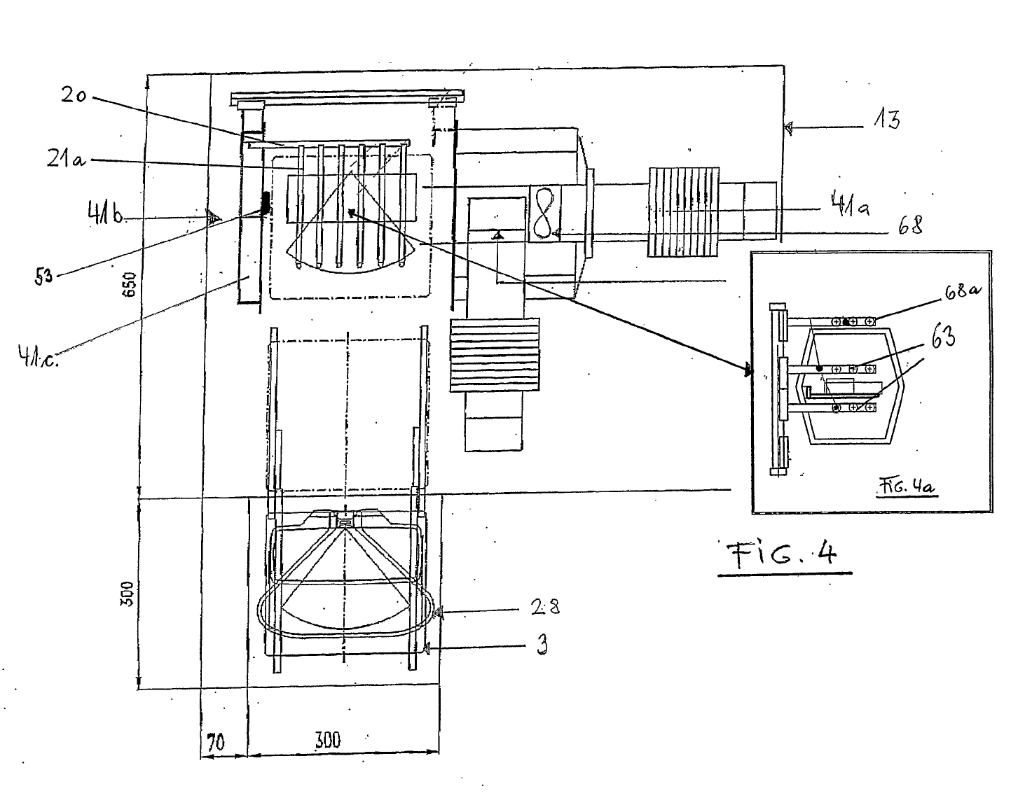

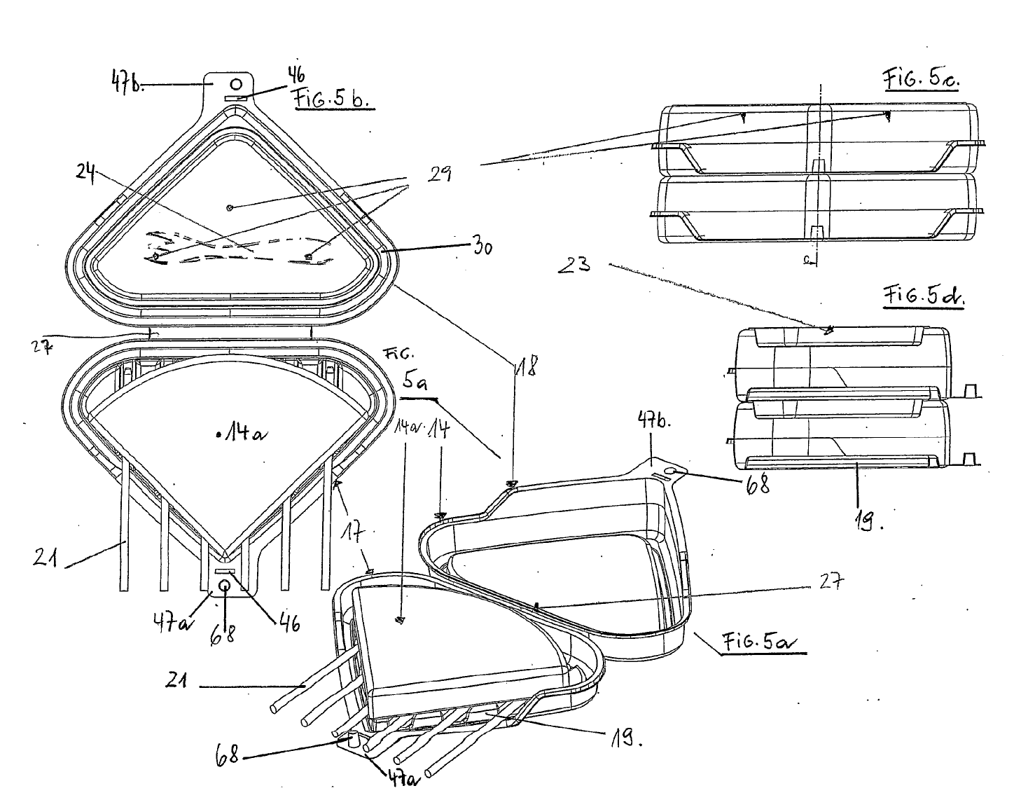

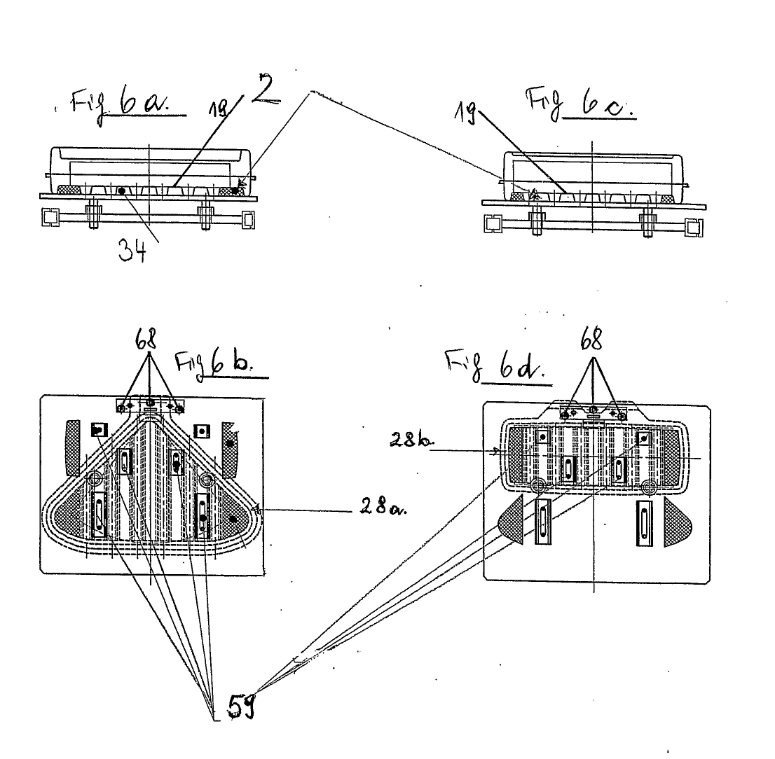

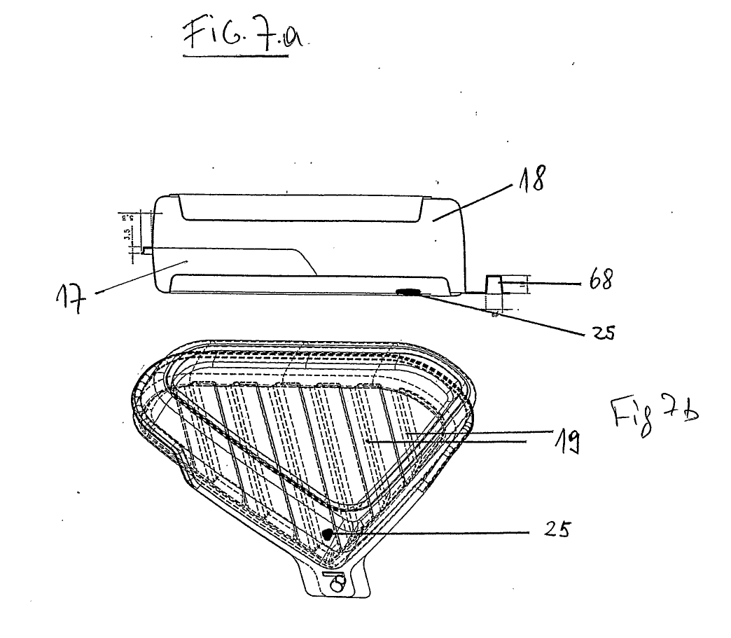

FIG. 3a is a side view of the special grill/fork with the moving wall to separate the heating cavity sections.

FIG. 3b is a plan view of the FIG. 3a

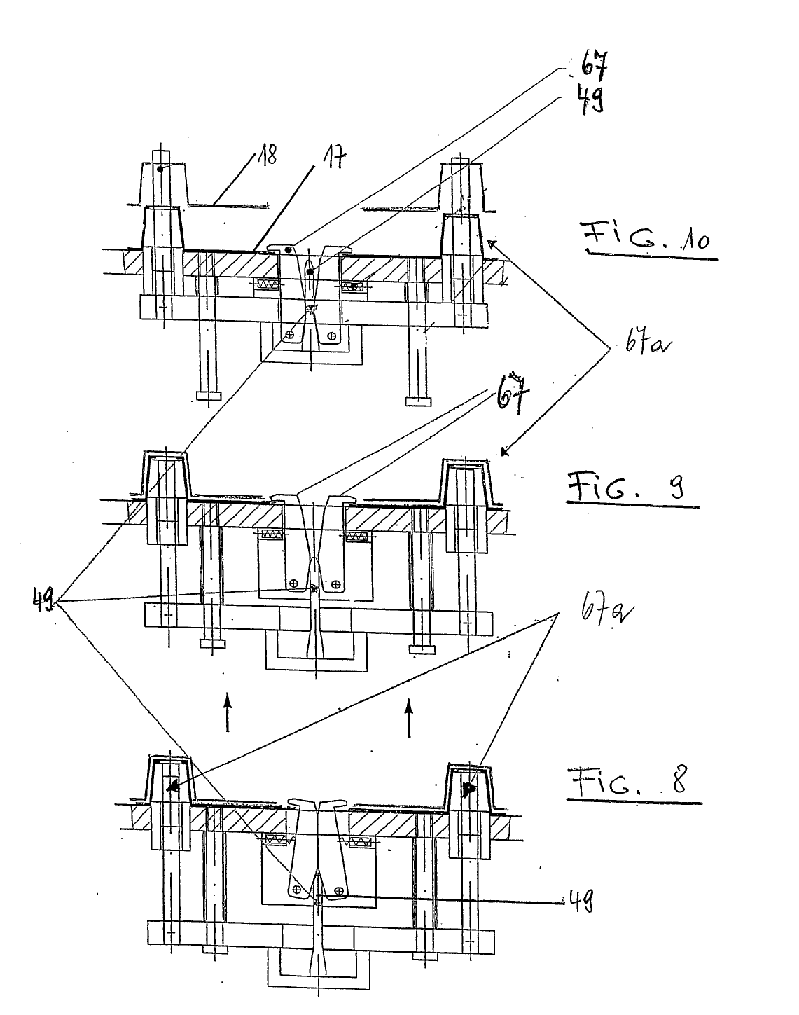

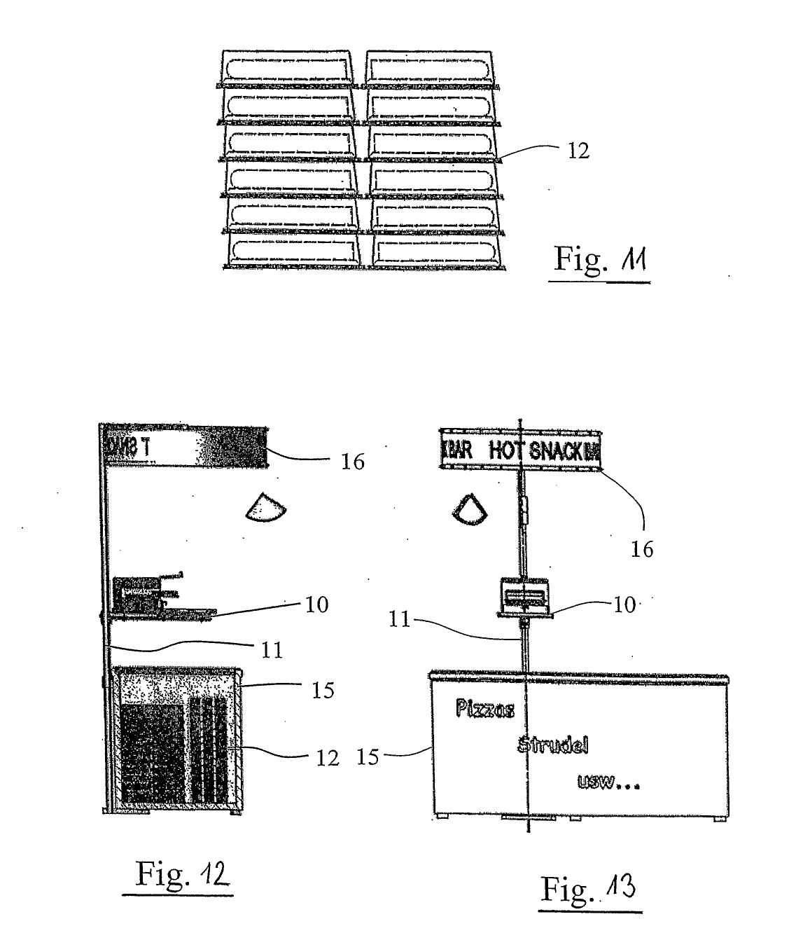

FIG. 4 is a plan view of the installation with a package on the schablone/receiver.

FIG. 4a is detained view of a part of FIG. 4.

FIG. 5a is the perspective view of the special features from a single portion package including the opening and closing of the package and the special lower package design to allow the grill fork to go underneath the snack food product to an and re-pack the snack food product automatically.

FIG. 5b is a plan view of the package of the FIG. 5a

FIGS. 5c and 5d are a frontal and lateral view of two closed stacked packages.

FIGS. 6a and 6c is a back view respectively of a triangular and a rectangular package with the food product and the schablone/receiver with the vacuum sucking holes.

FIGS. 6b and 6d are plan views of the FIGS. 6a and 6c.

FIGS. 7a, 7b, is respectively side view and a perspective view of a package showing the package in closed situation.

FIG. 8 to 10 is side view of the “hook-on-hole” in the schablone/receiver showing the opening of the package.

FIG. 11 is a side view of a package tower.

FIGS. 12 and 13 are side and front schematic view of packaged food products sales structure with the compact oven.

The main features of the preferred embodiment of the compact oven will be described with the help of figures The operative mode of some parts will be described in other sections.

The compact oven 13 (FIG. 2) comprises a box 13 with a cavity 41 separated in two cavity sections 41a and 41b (FIG. 4) of which are housed various elements. CPU means controls the operation of each element of the installation and a display. The TV Video screen 42 (FIG. 2), is used for handling instructions, and/or error messages to consumers and/or technicians and entertainment for the consumer during the waiting time. An infrared sensor 1 (FIG. 1a, 1b) controls the opening of the clap door 44. The oven front is made of strong see through material (PVC or glass). At least four but preferably six infrared heating tubes means are disposed above and below the moving grill/fork 20. The compact oven is also provided with a mono mode energy microwave heating system 64 around the cavity section 41b where the grill/fork 20 moves the snack food from one heating system to the other heating system.

A grill/fork 20 comprising several rods 21a, (FIG. 2, 3b) is provided for receiving the food product to heat. The shown grill/fork 20 comprises six rods 21a. Each rod has a diameter of about four mm. The rods and inner part of the cavity 41 are treated with nanotechnology surface treatment preventing grease or any burned leftovers to stick on them. The schablone/receiver 28 (FIG. 1a, 1b) pushes the portion packaging against the grill/fork 20, after it was opened by the hook on hole and bolt system 49, 67 (FIG. 8, 9, 10) and deposits the snack food product onto the grill fork 20 by lowering the schablone/receive 28 by 1 cm so unloading the product 14a on the grill/fork 20. The grill/fork 20 moves then side wards into the microwave cavity 41b. The on the grill/fork 20 mounted microwave cavity door 41c (FIG. 3a, 3b), closes and protects the microwave section 41b during the microwave heating process against the infrared cavity 41a. A ventilator 68 (FIG. 4) avoids spoiling sizzling food by blowing air via tubes allocated in the infrared cavity section 41a from the top back onto the food product and allows a better distribution of the heat in the cavity 41b. The infrared sensor 53 (FIG. 3a, 3b) measures and analyses the temperature and humidity of the food product before and during the heating process as it moves with the door 41c, and stops the heating once the optimum homogenous food product temperature of 55° C. is reached.

The box 13 is closed by door 44 (FIG. 1a, 1b) which is a clap adjusted on gliding rails mounted from top, and the opening and closing movement of the door 44, is assisted with a gear motor 60, underneath the door 44.

The multi shape schablone/receiver 28 is made of a metal frame 3 (FIG. 4) Once the sensor 1 (FIG. 1a, 1b) is activated the clap door 44 opens and the schablone/receiver 28 moves outward to receive the portion packaging. (FIG. 4) Integrated into the schablone/receiver 28 are four oval sucking holes 59 (FIG. 6b, 6d) which operate like a vacuum cleaner locking the plastic packaging 14 against the schablone/receiver 28. The positioning RFID (Radio Frequency Identification) chip reader 34 (FIG. 6a) confirms the proper position and is situated under the schablone/receiver 28.

The multi shape schablone/receiver 28 has a metal frame 3, (FIG. 4) with inside measures of approx. 23 cm×23 cm, ×15 mm high. The inside of the multi shape schablone/receiver 28, corresponds to the different shapes of the food packages and is made of plastic material. The triangular pizza portions package shape 28a, (FIG. 6a, 6b) measuring on the round outer side 22 cm long×16 cm wide, is formed into the multi shape schablone/receiver 28. In the same manner the shape of the paninis portion package shape 28b (FIG. 6c, 6d), which are approx. 22 cm long×8 cm wide, is formed into the schablone/receiver 28. A ready made menu package, measuring 22 cm×22 cm covers the whole of the multi shape schablone receiver 28. The positive matrix/relief's of the ribs (see below the package description), in the lower package's part, of the different food packages, is repeated in a negative matrix/relief's 2, (FIG. 6a, 6c) in the multi shape schablone/receiver 28, bottom pattern. Therefore the different shaped food packages can not be wrongly placed in the multi shape schablone/receiver 28.

The package 14, (FIG. 5a, 5b) enclosing the food product 14a, (¼ pizza, quiches, pie, panini, etc.) is made of an upper package part 18, and a reflective lower package part 17, hinged 27, on the rearward wall. The upper and lower portions are formed to match the shape of the food products 14a, but could have any other shape. In the description hereafter, triangular, for pizzas, pies, etc., and rectangular for paninis, baguette, strudel's, are used. The food package 14 can be a made of materials like polypropylene or carton, compressed paper etc., or any combination of materials.

The food package will now described with the help of FIGS. 5a to 5d, The food package 14 has a lower part 17 and an upper part 18 linked by reward hinge 27. The hinge 27 is elastically deformed in close position of the package.

Three fixations pointers 29 are integrated in the upper part 18. The fixation pointers 29, are approximately 8 mm long and sting from the top into the underneath placed food product 14a, by this, centering the food product in the package 14, during the distribution, until it is used on the point of sales, with the compact oven 13. In the lower package part 17, ribs 19 (FIG. 6a, 6c) are formed and integrated, which have the function to elevate the snack food 14a, allowing the rods 21, from the grill fork 20, to pass between them. The positive formed ribs 19 (FIG. 7), in the lower package part 18, (FIG. 6a, 6c) are repeated and matched by the negative ribs from the multi shape schablone/receiver 28. (FIG. 6a, 6c) 2. This ensures the correct positioning of the package 14, in a “no error position”. The reader device 34, has only access to the code RFID chip at the bottom of the lower part 18 of the package 14, and is able to recognize and activate the installation, if the package 14, is properly placed, therefore matching with the ribs 19 (FIG. 5a, 7b), and the form from the multi shape schablone/receiver 28, matrix.

In another function, the ribs 19 (5a, 5d) diminish the risk that the food product 14a, sticks to the food package 14, during a frozen distribution stage, which could happened if the food product would sit on a flat surface. In addition, the ribs 19, reinforce the strength of the food package's 14, structure.

The package container 14, has a stapling frame 30, (FIG. 5b, 5c) to assemble the package portions 14, in “snack towers” 12 (FIG. 11), configuration at the factory, for easy merchandising handling at the point of sales and attractive proper display in freezer cabinets 15 (FIG. 12, 13), or fresh food sections, at the point of sales in supermarkets, gasoline Stations, kiosk and for stapling or storing them in the freezers or frigidaires at the household's.

The food package 14 has a rectangular hole, the “hook on hole” 46, which is punched into the upper and lower package's tabs, 47a and 47b, (FIG. 5a, 5b). The rectangular hole of the lower packaging part 17, has the dimensions just big enough to let the totality of the “hook on bolt” device 49, 67 (FIG. 8-10), move through it, whilst the rectangular hole of the upper packaging part 17, is wider than the hole from the lower packaging. When the hook on bolt by his upward movement expands the quenches 67, side wards, the quench can only grip and press the lower part of the food package 14, to the multi shape schablone/receiver 28, as the “hook on hole” from the upper part 18 of the packaging 14, is to big to be catched by the quenches 67. Parallel with the hook on bolt's upward movement three other bolts 67a, (only two shown on the FIG. 8 to 10) move upwards into the opening domes 68. The opening dome hole 68 of the lowers packaging part 17 is big enough to let the bolts 67a, move through. The opening dome of the upper part 18 of the packaging 14, is covered and closed so that the bolts 67a, which move into the closed upper dome 68 and springs the two packaging parts of the food packaging open as the lower part is pressed to the schablone/receiver 28, by the quenches 67 and the vacuum suckers. The tension arising from the elastically deformed rearward hinge 27 the upper part 18 spring opens in a angle of approx. between 35°-45° and give access to the food product 14a. If the package is a triangular one only one of the bolts 67a (the middle one) will 45° In FIGS. 8 to 10 the package represented is a rectangular package (see FIG. 6c, be in contact with domes 68.

The packaging bears a RFID chip, containing the individually product parameters encoded optimum heating sources and processing instructions (heat force, source, time), per individual food item. The RFID chip, is recognised and read by the reader device 34. The RFID chip may be glued directly on the lower package's 18 bottom or is moulded into the plastic container. The RFID chip initiates also the start and finish program of the installation. The reader 34 is adjusted in such an angle that he is only able to read the instructions label 25, when the food package's 14, ribs 19, are matched and fit into the ribs from the multi shape schablone/receiver 28, indicating that a package 14, is in the correct position, to be reheated.

In another advantage, the package 14, includes an “all in pack” eating utensil 24, (FIG. 5b) adding the possibility, for a napkin/label 23 (FIG. 5d) fork, etc. A recess in the upper part 18, of the food package 14, allows room for a napkin/label 23, and an eating utensil, (pp. fork, knife, or spoon) which are held in place and hygienically covered in the recess by the napkin/label 23. (FIG. 5d). On the label 23 UPC and legal marketing information are printed. The label 23, (FIG. 5d) is wrapped and glued around the upper part 18 of the package 14.

The hygienic and tamper proof safety control, is secured with the label 23, which with one tongue part overlaps the package lower part 17, which, once ripped open, can not be repaired, and makes it obvious that the package 14, was opened or mismanaged.

The operation process of the installation will be described.

The glass or plastic front 31 (FIG. 2) has the important function to protect the user or consumer from any heat or mechanical related injury, by covering the total forefront and top of the compact oven 13. The second function of the front 31 is the protection of the compact oven 13, and the automation of the multi shape schablone/receiver 28, from mishandling or mismanagement and to keep compact oven equipment clean. In the hood integrated is the clap door 44, which is activated by an infrared sensors trigger 1, for opening. Once the human hand (FIG. 1a, 1b)(with wave symbols, similar to hand dryers etc.) approached and activated, the clap 44 slides upwards (FIG. 1a), moving the multi shape schablone/receiver 28, through the clap door 44 (FIG. 1a) The user has now access to the multi shape schablone/receiver 28, to place the food package 14, into the multi shape schablone/receiver 28. When the package is correctly positioned on the schablone receiver the reader device 34 reads RFID chip 25 bearing the individually encoded optimum heating parameters and processing instructions (heat force/source/focus/time), per different food item and starts the automated heating process. In case the food package 14, is removed from the multi shape schablone/receiver 28, (or for any other reasons/damaged package etc.) before the reader device 34 is able read the food instructions by the RFID chip 25 (FIG. 7), the clap will secure the totality of the compact oven 13, forefront by closing it.

The CPU has the optimum heating quality parameters per food product 14a, programmed and stored. Once the reader device 34 starts transferring the coded cooking instructions the clap 44 closes. Only now, when the exact placement is confirmed by the chip/reader the packaging is sucked against the schablone/receiver and the hook on bolt moves as described above.

By the movement of the schablone/receiver 28 onto the empty grill fork 20 the snack product 14a, is removed from the package 14, by a 1 cm downward movement of the schablone/receiver, by this movement unloading the food product on the grill and then moving back with the empty packaging in the starting position of the schablone/receiver.

The grill/fork 20 moves with the snack product on it, now sidewards into the microwave cavity section 41b and closes with the microwave door 41c the section to the infrared cavity 41a (receiver and first cavity). After the microwave heating is completed the grill moves side wards back into the position where is started from into the first cavity where the infrared tubes not shown are mounted and now heat the snack and remove the moist and dry the surface of the snack to achieve crispness if demanded by the products parameters. Once the optimum procedure is confirmed by the infrared temperature measurer 53 (FIG. 3a, 3b) the heating is stopped and the schablone/receiver moves forwards to the grill/fork 20. The empty packaging is still sitting with the upper part sprung open on the schablone/receiver and moves now underneath the grill forks ribs, and with a 1 cm upward move is lifting the snack food onto the lower part of the packaging container returning the food product 14a in it's package 14. The closing of the upper packaging part is in connection with the backward (outward) movement through the clap door, where guiding rails catch the upper part of the packaging container and slide it onto the lower part with a slight pressure which click's it together.

All the heating data are permanently compared with the optimum heating quality parameters stored in the CPU, which then according to the sensed data, calculates, selects and activates the heat source, operating either the microwave magnetron 64, or the infrared device 63 (FIG. 4a), allocates the time per heat source, and directs the grill/fork 20. A heating quality analysis sensor 53 (FIG. 3a, 4) provides the versatility which make it possible to heat snack food products 14a which have different products temperatures at the start, to reheat with the same equipment, operating from minus −20° Celsius for deep frozen to fresh snack food products temperatures of +5° to +24° Celsius. The sensor 53 measures at three different spots the characteristics at the start and during the heating period comparing the data with the stored optimum heating quality parameters. Very greasy food products 14a will be placed in sulphide paper capsules, to protect the cavity 41 against soiling. To place the food product in sulphide paper capsules before packing them into the polypropylene package might be necessary for food products where parts of the food might melt and drip during the heating process, for example pizzas with cheese topping. For the same reason and in order to reduce the sizzling or sprinkling of hot grease from cheese toppings etc. a small, air circulating ventilator 68, will blow from above onto the food product 14a via the tubes 68a (FIG. 4a) allocated above the infrared tubes, pressing the eventually sizzling food material back onto the pizza slice etc. Heating elements, in the form of mono mode microwave technology when combined and used together with infrared devices as heating sources in one cavity create problems of electronic interference and unreliability. For this reasons the separation of the big cavity in two independent cavity sections with the innovative closing of the microwave cavity with the movable door 41c mounted on the grill/fork has an important impact on the long term reliability of the equipment and allows secure and unproblematic operations on the point of sales.

In order to respond with the compact oven 13 to company related (Fast food operators for Hamburgers, spring rolls etc.) or other ethnic/national food producers preferences, for different sizes, shapes, weight etc., the compact oven 13 operator, needs only to exchange the multi shape schablone/receiver 28, with a multi shape schablone/receiver, made to his preferred form and weight of food and package 14. As the rods 21a have the same norms when moving through the lower ribs 19, in the same channels, the rest of the procedure with another product shape is executed as before.

As the rectangular panini food package 14, are exactly half the size as the Pizza triangle's, food package 14 and as the packages have the common feature that the “hook on hole” 46 is in the same shape and size at the same spot at the package 14, the product is handled like the pizza ¼ slices. The user or consumer can take it now without risk to buni the fingers, as the food package 14 remained at room temperature, and stayed outside of the compact oven 13, and because the rib's 19 and the fixation pointers 29 prevent the hot food product 14a to touch the two surfaces of the package 14.

The perfect position for convenient take out by the user or consumer is arranged when the reader device 34 no longer detects the instructions RFID chip 25, indicating that the food package 14 has been removed from the schablone/receiver 28, the schablone/receiver slides back through the clap door 31, which closes the front protecting the compact oven, and the schablone/receiver 28.

For easy cleaning or changing the schablone/receiver 28, the inner part of the schablone/receiver can be taken out of the schablone/receiver 28 metal frame.

1. Installation for reheating portioned chilled or frozen hot snack food products packaged in a lower and upper hinged package parts closed by cooperation of snap means, comprising a compact oven provided with microwave and infrared heating section means located inside the oven cavity, means for reading a heating instructions label located on the package of the food product and CPU means for controlling the compact oven, wherein the compact oven cavity is closed by a clap, in that it is provided with a schablone/receiver shaped to receive and accurately arrange to unpack automatically the food product from the package allowing the re-heating and crispness process to achieve without the package, in that the oven is provided with means to open automatically the package of the food product, and places it automatically onto a grill/fork device and move it through the oven cavity provided with two different heating and crispness systems and purposes, said grill/fork device being provided with means allowing the grill/fork device under the CPU control to be moved inside the oven cavity and take the heated food product moving it back and by doing so re-package the hot food product automatically into the original package, in that the schablone/receiver is provided with means controlled by the CPU designed to close this package containing the heated food product, and by pressing down the upper part of the package until the snap means are re-engaged for secure and convenient self-service take out by the consumer or user.

2. Installation according to claim 1 wherein the oven cavity comprises two sections separated by a door, a first section provided with the infrared heating means, and a second section provided with the microwave heating means, in that the two sections are separated by a fix mounted microwave closing door, in that the grill/fork device is designed to move forwards and backwards inside the first cavity section and side wards between the first and second cavity sections.

3. Installation according to claim 2, wherein the first cavity section is provided with a ventilator to blowing air onto the food product from above avoiding spoiling sizzling food to dirty the cavity.

4. Installation according to claim 2, wherein the grill/fork is designed to operate side wards serving both heating systems in two different cavity sections with the integrated microwave secured closing door allowing the microwave system to heat the mass of the food product, and the infrared heating to achieve the necessary crispness.

5. Installation according to claim 1, wherein the infrared heating system is provided with tubes underneath and above the grill/fork which are stirred by a heat controller device to be moved as close as possible to the surface of the un-packaged food product to achieve maximum crispness.

6. Installation according to claim 1, wherein the cavity is provided with a sensor device controlled by the CPU means and designed to penetrate the food product to sense temperature and humidity parameters of the product before and during the heating to stop or to extend heating of the product identified by a RFID (Radio Frequency Identification) chip which constitutes the said label.

7. Installation according to claim 6, wherein the sensor device comprises three sections designed to penetrate the food product, one into the middle part of the food product and the others near the side to measure homogeneous heating quality.

8. Installation according to claim 1, wherein the grill/fork device comprises several rods which are designed to unload and reload the food snack into the package automatically and move it into the two cavity sections.

9. Installation according to claim 8, wherein the schablone/receiver is designed to lift automatically the food product out of the packaging and onto the grill.

10. Installation according to claim 1, wherein it is designed to move the food product after the heating processes from the grill and to repackage the food product automatically into the original packaging, and to close it automatically disposing it through the oven clap for convenient self service take away by the consumer.

11. Installation according to claim 1, wherein the schablone/receiver is provided with means designed to transport, unpack and repackage the food product after the heating process.

12. Installation according to claim 1, wherein the lower package part is provided with ribs allowing to elevate the food product out of the lower package of the schablone/receiver to accurately positioning the package on the grill or back onto the schablone/receiver.

13. Installation according to claim 1, wherein each of the two package parts is provided with a “hook on hole” opposed to the hinged edges, and provided with matching domes allowing automatic open and closing and to be back clicked into each other again holding the package in closed condition.

14. Installation according to claim 1, wherein the hinge is elastically deformed in closed condition of the package and a outside frame is used for closing the package after the heating by gliding backwards and closing it onto the lower packaging part.

15. Installation according to claim 1, wherein the upper package part is provided with integrated pointers stinging from the inside face of the upper package part into the underneath food product allowing to hold centred the food product.

16. Installation according to claim 13, wherein the schablone/receiver is provided near the door of the oven with a bolt and quenches device designed to be moved upwards and downwards, the dimension of which match the dimensions of the “hook on hole” in the upwards position the bolt prevents the package from moving.

17. Installation according to claim 3 wherein the ventilator of the microwave cooling system is also designed to produce a vacuum to suck the lower part of the packages against the schablone/receiver for additional fixation for controlled automatic take in and out lifting of the food snack from the package container.

18. Installation according to claim 6, wherein the RFID chip moulded into the packaging container is designed to receive_and transmit via the CPU daily commercial and technical and maintenance data transfer via satellite to a main frame computer.

19. Installation according to claim 1, wherein it integrates a TV screen on the front of the oven for handling instructions, entertainment during the heating time, or advertising synergy related consumer products like soft drinks, Coffee etc.

20. Installation according to claim 1, wherein the schablone is designed to allow uncomplicated change of shape, size or weight, by the inner schablone/receiver with easy cleaning and maintenance, plus maximum flexibility for the resellers or household's convenience.
